(19) United States
(12) Patent Application Publication
(10) Pub. No.: US 2015/0310395 A1
(43) Pub. Date: Oct. 29, 2015

(54) SYSTEM AND METHOD OF PLACING JOB CANDIDATES

(71) Applicant: Christopher Shepherd, Cranston, RI (US)

(72) Inventor: Christopher Shepherd, Cranston, RI (US)

(21) Appl. No.: 14/699,254

(22) Filed: Apr. 29, 2015

Related U.S. Application Data
(60) Provisional application No. 61/985,542, filed on Apr. 29, 2014.

(51) Int. Cl. G06Q 10/10

(52) U.S. Cl. CPC G06Q 10/1053

(57) ABSTRACT

A method of placing job candidates with a prospective employer is disclosed where a plurality of personal qualities from a job candidate is collected, a score to each of the personal qualities is assigned, an assessment score for the job candidate factored from the scores assigned to each of the personal qualities is calculated; and the job candidate is ranked in accordance with an employer's pre-selected criteria for job candidates.

### CROSS-REFERENCE TO RELATED APPLICATION

This patent document claims priority to earlier filed U.S. Provisional Patent Application No. 61/985,542, filed Apr. 29, 2014, the entire contents of which are incorporated herein by reference.

### BACKGROUND

1. Technical Field

The present patent document relates generally job placement and more particularly to matching students and recent graduates to employers with job openings.

2. Background of the Related Art

Job placement for individuals seeking employment and employers seeking job candidates for college students and recent graduates is often accomplished through job fairs and career services offices of the university or college. The process is inefficient and does not guarantee that the best candidates will be matched to the best employers, relatively speaking.

Therefore, there is a perceived need in the industry for a more efficient method of matching job candidates to employers.

### SUMMARY

The present invention solves the problems of the prior art by providing a method and system of placing job candidates that obtains employer job criteria and prospectively matches the criteria to the skill set and other criteria of available job candidates. The employer may then seek to interview and hire the available job candidates to fill the employer's open positions.

### BRIEF DESCRIPTION OF THE DRAWINGS

These and other features, aspects, and advantages of the present invention will become better understood with reference to the following description, appended claims, and accompanying drawings where:

FIG. 1 shows an illustration of a computer server of the system and method of placing job candidates;

FIG. 2 shows an illustration of job candidates and employers interacting with the computer server of the system and method of the placing job candidates;

FIG. 3 shows a screenshot of a login screen of the system and method of placing job candidates;

FIG. 4 shows a screenshot of a terms of service screen of the system and method of placing job candidates;

FIG. 5 shows a screenshot of results of a query for job candidates of the system and method of placing job candidates;

FIG. 6 shows a screenshot of the results further restricted by additional search criteria;

FIG. 7 shows a screenshot of a view candidate details window from the queried results of the system and method of placing job candidates;

FIG. 8 shows a screenshot of an assessment score of a particular job candidate generated by the system and method of placing job candidates;

FIG. 9 shows a screenshot of a job candidate entry and editing screen for adding and/or modifying a job candidate to/in the system; and

FIG. 10 shows a flowchart of steps of placing job candidates with an employer.

### DESCRIPTION OF THE PREFERRED EMBODIMENT

The method and system of placing job candidates from universities and colleges with employers described herein works in partnership with career services offices of the respective universities and colleges. Through the partnership, the career services office creates a job candidate profile of each participating student in the system. Each student verifies its application as a job candidate and optionally uploads a resume into the system. Each employer that has employment openings also creates an account, described further below, and describes the job openings available. Based on the criteria set by the employer for the open positions and the characteristics defined for each job candidate, the system matches job candidates with open positions. Based on the matches presented to the employer, the employer can seek authorization from the career services office for permission to contact the student about the employment opportunity and to schedule and interview if the student is interested.

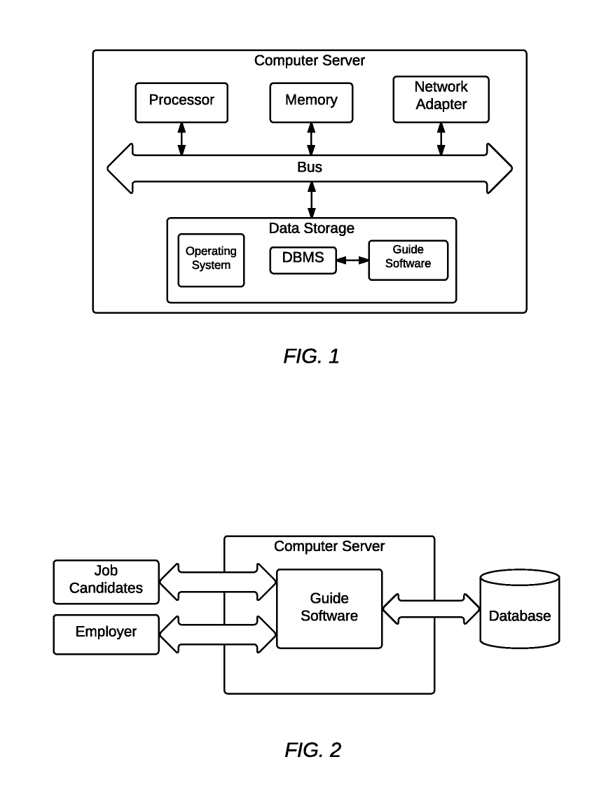

It should be understood that the system and method of placing job candidates may be employed in any type of operating system. The system and method may be implemented in any type of software code using any language and can run on any type of computer hardware or networked computer hardware, including virtual machines. As shown in FIGS. 1 and 2, an exemplary computer server, virtual or physical, generally includes a processor, a program memory, and a data storage. The computer server may be networked, wired and wirelessly, to other computer servers or r3emote storage systems, such as database management systems, and accessible via other electronic devices, such as smartphones, PDAs and the like. Job candidates and employers may interact with the computer server via a conventional web browser or proprietary portal software as desired. The storage may be internal to the computer server or remote, on another network attached storage device or computer server.

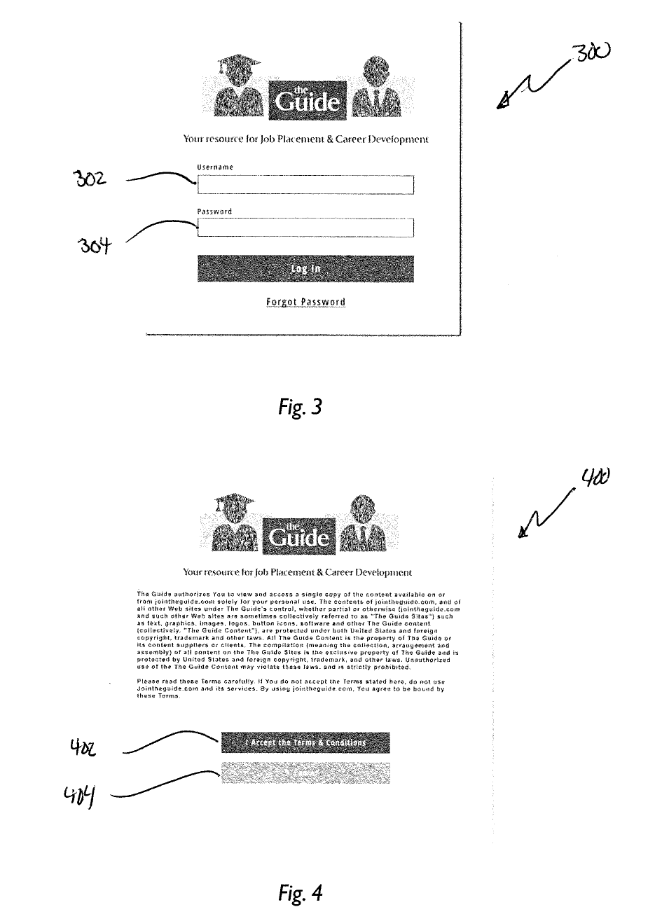

Referring now to FIG. 3, initially the employer is presented with a login screen 300, where the employer enters a user name 302 and password 304 to access the system.

Referring to FIG. 4, the first time an employer accesses the system, the employer is presented with and must accept the terms and conditions 400 of using the system, including maintaining privacy of the job candidates. Selecting the “I accept the terms and conditions” button 402 allows the employer to advance into the system. Otherwise, the employer must select the “Cancel” button 404 and exit the system.

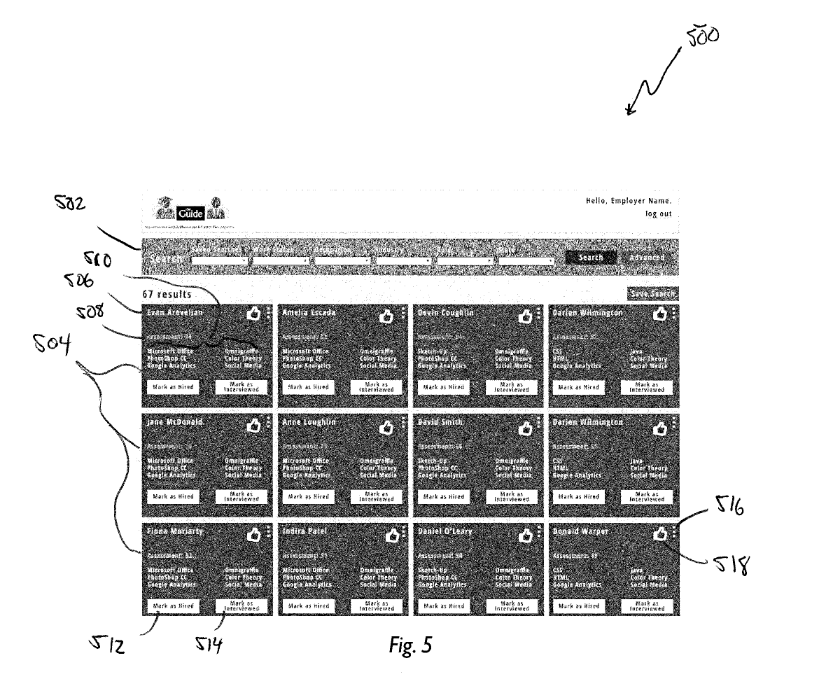

Referring now to FIG. 5, after logging in and accepting the terms and conditions of using the system, the employer is presented with a dashboard 500 having a search bar 502 and a number of job candidates, pre-selected and vetted by the system according to desired positions, skill and aptitude. Each job candidate is presented on its own tile 504 and includes the job candidate's name 506, a color-coded numerical assessment score 508, and an abbreviated list of pertinent skills 510. The tiles 504 may be arranged in a grid. Each tile further includes buttons 512, 514 for marking the job candidate as either “Hired” or “Interviewed,” respectively. The tile further includes a “View Candidate Details” button 516, indicated by the three vertically-stacked squares in the upper right corner of each tile 504.

The employer may further “like” one or more job candidates by selecting the “like” icon or button 518. In response to the likes, the system will skew search results of job candidates to present job candidates that are similar to the “liked” job candidates thereby providing job candidates that may prove to be more tailored to the employer's desires.

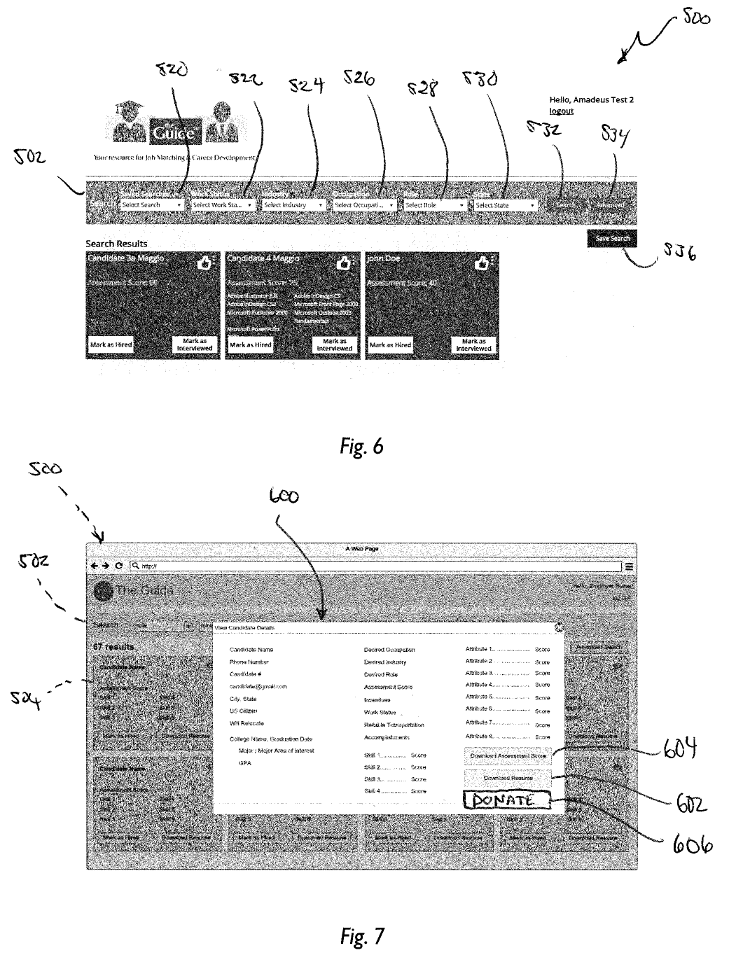

Referring to FIG. 6, the queried results may be further narrowed or winnowed by adding additional search criteria via the search bar 502, thereby reducing the total number of job candidates returned in the initial match. The search bar 502 may further have preselected search criteria such as previously saved searches 520, work status 522, industry 524, occupation 526, role 528, and state 530 via drop-down listboxes. A “Search” button 532 is provided to search the job candidates to perform a serach based on criteria selected in the drop-down listboxes. An “Advanced” button 534 is provide to allow for more refined searching on other criteria. A “Save Search” button is provided to save the selected search criteria in the listboxes into an entry which is sotred in the “Saved Searched” listbox for subsequent use.

Referring to FIG. 7, selecting the “View Candidate Details” button 516 invokes a detailed view 600 of that particular job candidate. The detailed view includes a complete list of the job candidate's skills, contact information, citizenship, availability to relocate, education and gpa, and personal qualities. Other notes and details may also be included about the job candidate. A “Download Resume” button 602 is provided to download the job candidate's resume, if one had been previously uploaded into the system. A “Download Assessment Score” button 604 is provided to obtain a detailed report of the job candidate's compatibility with the employer. Selectively revealed to the job candidate when a job candidate is logged into the system, a “Donate” button 606 may be shown which provides the university or college an opportunity to solicit a donation from a job candidate.

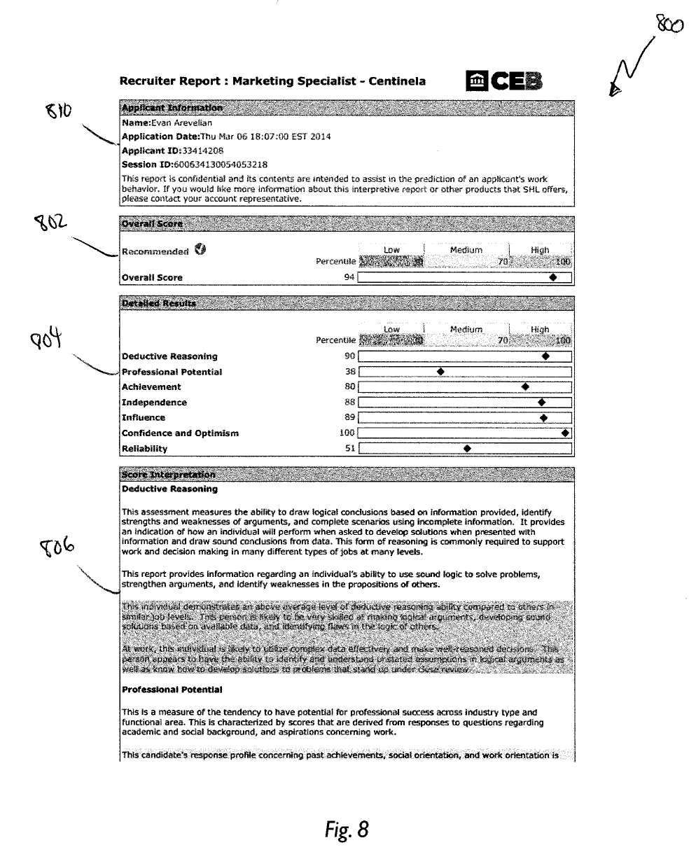

Referring to FIG. 8, a screenshot of a detailed recruiter report 800 is shown, which provides a detailed breakdown of the calculation of the assessment score calculated for that particular job candidate vis-à-vis the employer at overall score section 802 of the report 800. The assessment score may be a numerical score from 1-100, calculated based on personal qualities, such as, Deductive Reasoning, Professional Potential, Achievement, Independence, Influence, Confidence and Optimism, and Reliability. Each characteristic may be individually numerically scored from 1-100 shown in detailed results section 802 of the report 800. Other numerical ranges may be used as well, such as 0-5 for the assessment score and each characteristic for instance. The ratings of the qualities are calculated to together via a proprietary formula that weights and correlates the personal qualities scores to arrive at the assessment score. In one such method, the assessment score is calculated by the average of the personal qualities scores. In addition to the personal quality score, a color-coded explanatory paragraph is provided that describes the nature of the score and the match to the employer's requirements at the score interpretation section 806 of the report 800. The report 800 also includes an applicant information section 810, which identifies the job candidate that the report 800 was prepared for.

The job candidate may further include assessments of additional personal qualities such as, but not limited to, Awareness, External Distract-ability, Analytical/Conceptual, Internal Distract-ability, Action/Focused, Flexibility, Information Processing, Orientation towards Rules & risk, Control, Self Confidence, Extroversion, Introversion, Expression of Ideas, Expression of Criticism & Anger, Expression of Support & Affection, Persuasive language, Problem Solving, Thoroughness, Management Potential, Drive for Success, Innovation, Service Professionalism, Customer Focus & Customer, Orientation, Analytical, Persistence, Sales Potential, Sales Drive, and Confidence and Independence. These personal qualities and/or “soft” skills may be observed and quantified by detailed personality tests. Each of these personal qualities may also be individually scored from 1-100 and factored into the assessment score.

Employers may further “like” personal qualities, thereby increasing the weight assigned to that personal quality when calculating the assessment score. The weight assigned may be a multiplier to the personal quality score or fixed sum added to the personal quality score, prior to calculating the assessment score for the candidate, thereby increasing the job candidate's ranking as a possible match for that employer.

The employer may “like” other job candidate attributes, such as, for example, degree, gpa or willingness to travel in order to increase potential matches with those desirable characteristics, in addition to limiting the pool of potential job candidate matches via search criteria.

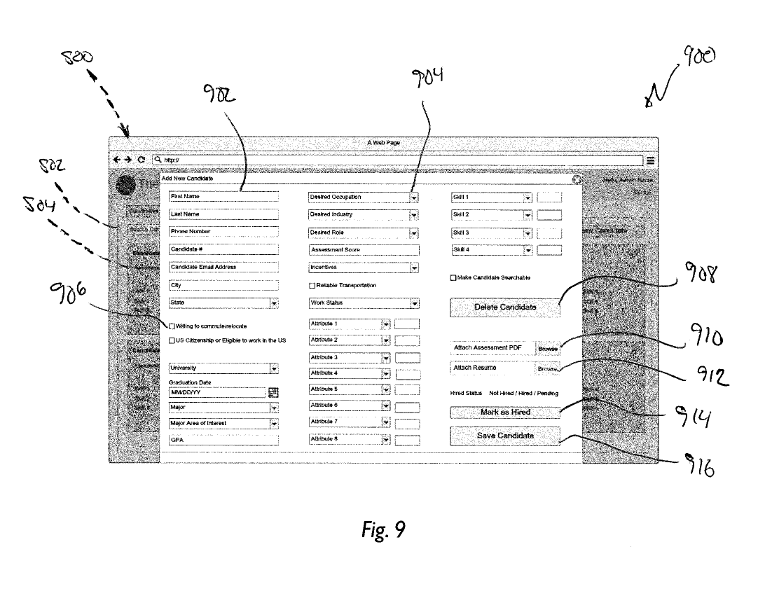

Referring to FIG. 9, a screenshot of a job candidate entry and editing screen 900 is shown, where the details of a job candidate may be entered and/or modified. The screen includes editable textboxes 902, dropdown listboxes 904, and checkboxes 906 for the job candidate's characteristics and personal qualities to be deleted, edited or entered, and saved. A “Delete Candidate” button 908 is provided to delete a job candidate entirely from the system. Buttons 910, 912 are also provided to attach, respectively, an assessment report and resume to the job candidate. A “Mark Hired” button 914 to mark the job candidate as hired. A “Save Candidate” buttin 916 is provided to save all edits and changes to the job candidate in the system.

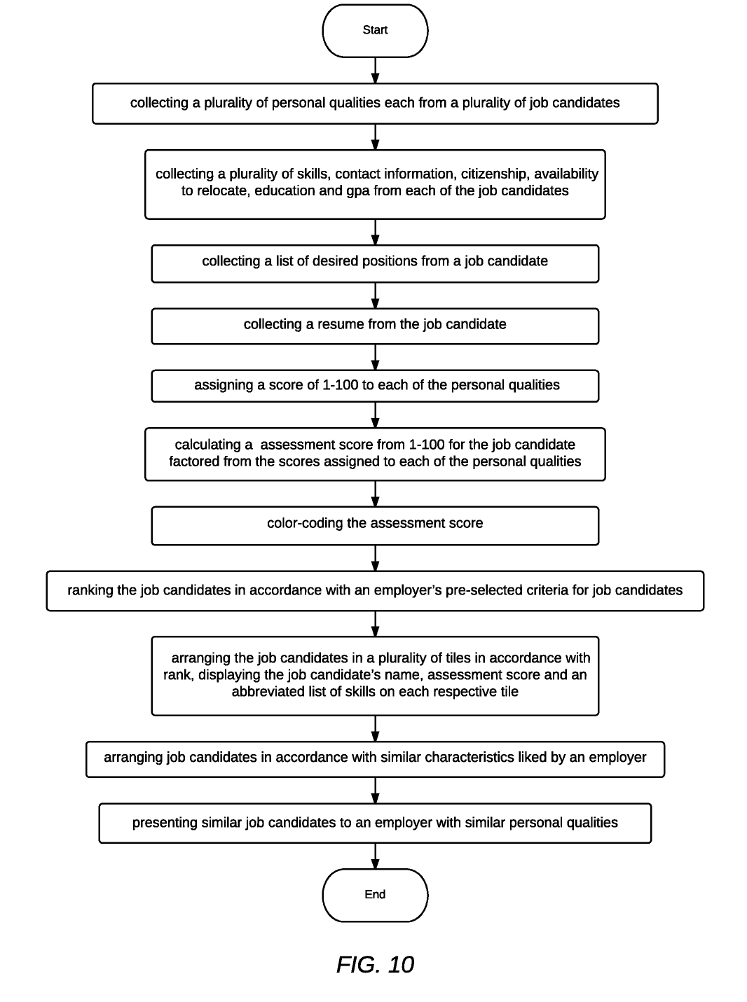

As described above in connection with the screenshots of the method and system, a flowchart is illustrated in FIG. 10, which shows the steps of the method generally. The method and system generally includes collecting the personal qualities from the job candidates, including the job candidate's skills, contact information, citizenship, availability to relocate, education and gpa, a resume and a list of desired positions the job candidate is seeking. Each of the personal qualities is assigned a score, (such as 1-100). An assessment score is calculated from the personal qualities, which may also be a numerical score (such as 1-100) and may be color-coded. The job candidates are ranked in accordance with pre-selected criteria obtained from the employer. The job candidates are then arranged on a series of tiles with identifying information. The arrangement of the tiles of job candidates may further be enhanced through employer selection of desired personal qualities or other characteristics and similarity to other desirable job candidates.

Therefore, it can be seen that the system and method provides a unique and efficient framework for matching job candidates to employer positions based on employer desired characteristics of the job candidates and job candidate qualifications and desires. Accordingly, better employer-job candidate matching may be accomplished leading to higher retention rates of employees.

It would be appreciated by those skilled in the art that various changes and modifications can be made to the illustrated embodiments without departing from the spirit of the present invention. All such modifications and changes are intended to be within the scope of the present invention.

What is claimed is:

1. A method of placing job candidates with a prospective employer, comprising:
collecting a plurality of personal qualities from a job candidate;
assigning a score to each of the personal qualities;
calculating an assessment score for the job candidate factored from the scores assigned to each of the personal qualities; and
ranking a job candidate in accordance with an employer's pre-selected criteria for job candidates.

2. The method of claim 1, further comprising collecting a plurality of skills, contact information, citizenship, availability to relocate, education and gpa from the job candidate.

3. The method of claim 1, further comprising collecting a resume from the job candidate.

4. The method of claim 1, further comprising color-coding the assessment score.

5. The method of claim 1, further comprising collecting a list of desired positions from a job candidate.

6. The method of claim 1, further comprising a plurality of job candidates.

7. The method of claim 6, further comprising arranging a plurality of job candidates in a plurality of tiles, displaying the job candidate's name, assessment score and an abbreviated list of skills.

8. The method of claim 1, further comprising wherein the score assigned to each of the personal qualities is a numerical score from a discrete range of numbers from 0-100.

9. The method of claim 1, further comprising wherein the assessment score is a numerical score from a discrete range of numbers from 0-100.

10. The method of claim 1, further comprising wherein the assessment score is calculated by an average of the scores of the personal qualities.

11. The method of claim 6, further comprising arranging job candidates in accordance with similar characteristics liked by an employer.

12. The method of claim 6, further comprising presenting similar job candidates to an employer with similar personal qualities.

13. A method of placing job candidates with a prospective employer, comprising:
collecting a plurality of personal qualities each from a plurality of job candidates;
collecting a plurality of skills, contact information, citizenship, availability to relocate, education and gpa from each of the job candidates;
assigning a score to each of the personal qualities;
calculating an assessment score for the job candidate factored from the scores assigned to each of the personal qualities; and
ranking the job candidates in accordance with an employer's pre-selected criteria for job candidates and;
arranging the job candidates in a plurality of tiles in accordance with rank, displaying the job candidate's name, assessment score and an abbreviated list of skills on each respective tile.

14. The method of claim 13, further comprising collecting a resume from the job candidate.

15. The method of claim 13, further comprising color-coding the assessment score.

16. The method of claim 13, further comprising collecting a list of desired positions from a job candidate.

17. A method of placing job candidates with a prospective employer, comprising:
collecting a plurality of personal qualities each from a plurality of job candidates;
collecting a plurality of skills, contact information, citizenship, availability to relocate, education and gpa from each of the job candidates. assigning a numerical score from a discrete range of numbers from 0-100 to each of the personal qualities;
calculating a color-coded assessment score for the job candidate factored from the scores assigned to each of the personal qualities;
ranking the job candidates in accordance with an employer's pre-selected criteria for job candidates; and
arranging the job candidates in a plurality of tiles in accordance with rank, displaying the job candidate's name, assessment score and an abbreviated list of skills on each respective tile.

18. The method of claim 17, further comprising wherein the assessment score is calculated by an average of the scores of the personal qualities.

19. The method of claim 17, further comprising arranging job candidates in accordance with similar characteristics liked by an employer.

20. The method of claim 17, further comprising presenting similar job candidates to an employer with similar personal qualities.
